(19) United States
(12) Patent Application Publication
(10) Pub. No.: US 2007/0028182 A1
(43) Pub. Date: Feb. 1, 2007

(54) Device and method for displaying a user interface window

(75) Inventor: Sook-hyun Kong, Hwascong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/492,795

(22) Filed: Jul. 26, 2006

(30) Foreign Application Priority Data
Jul. 27, 2005 (KR) 10-2005-0068610

(51) Int. Cl. G06F 9/00

(52) U.S. Cl. 715/764; 715/781; 715/810; 715/835

(57) ABSTRACT

A user interface display device and method are provided. The apparatus includes a process history storage unit for storing path information of a displayed user interface window, a user interface unit for displaying one or more second user interface windows, and a control unit for outputting a multiple-up instruction signal instructing the user interface unit to display a user interface window corresponding to the stored path information. The first user interface window is a current user interface window, and the second user interface windows are previously displayed user interface windows at a higher level than the first user interface window. Therefore, it is possible for a user to visualize the path of the user interface windows switched through to reach the current user interface window. Further, complicated keystrokes for switching from the lower level user interface window to the user interface window desired by the user are not required.

### CROSS-REFERENCE TO RELATED PATENT APPLICATION

This application claims the benefit under 35 U.S.C. § 119(a) of Korean Patent Application No. 10-2005-0068610, filed on Jul. 27, 2005, in the Korean Intellectual Property Office, the entire disclosure of which is hereby incorporated by reference.

### BACKGROUND OF THE INVENTION

1. Field of the Invention

The present invention relates to a display device and method. More particularly, the present invention relates to a device and method for displaying a user interface window desired by a user among user interface windows at a higher level than a current user interface window by displaying a user interface window selected from a multiple-up display window when the multiple-up display window is requested by a user.

2. Description of the Related Art

A user working with a user interface window displayed on a display unit such as a touch-screen or a liquid crystal display panel can instruct a display device to display a user interface window at a higher or lower level than the currently displayed user interface window. For example, when a user interface window displays a menu, a user may select a menu item, and a new, lower level user interface window corresponding to the selected menu item is displayed.

When a user selects a lower level user interface window while an upper level user interface window is displayed, the lower level user interface window is displayed, even if the lower level user interface window was selected by mistake, and the user does not want the lower level user interface window to be displayed. In this case, if the user wants to return to the upper level user interface window, the user typically presses a cancel key.

When the upper level user interface window that a user wishes to display is at a much higher level than the current lower level user interface window, a user may be required to perform many complicated keystrokes to return to the desired upper level user interface window.

In addition, conventional user interface display devices are unable to remind a user of the path to follow to reach a lower level user interface window. If a displayed user interface window was reached through a complicated path, the user may forget the path that the user took to reach the displayed user interface window. Thus, the user may have trouble recreating the path at a later time to return to the displayed user interface window.

In addition, when there are multiple user interface windows at a higher level than the current user interface window, the user may be required to perform complicated keystrokes to switch to a specific, desired upper level user interface window. When the current user interface window was reached through a complicated path, it may be very difficult to reach the desired upper level window.

Accordingly, there is a need for an improved device and method for displaying a user interface window which allows a user to conveniently select a desired user interface window for display.

### SUMMARY OF THE INVENTION

An aspect of the present invention is to address at least the above problems and/or disadvantages and to provide at least the advantages described below. Accordingly, an aspect of the present invention is to provide a user interface display device for displaying a user interface window desired by a user among user interface windows at a higher level than a current user interface window by displaying a user interface window selected from a multiple-up display window when the multiple-up display window is requested by the user working with the displayed lower level user interface window.

Another aspect of the present invention is to provide a method of displaying a user interface window desired by a user among user interface windows at a higher level than a current user interface window by displaying a user interface window selected from a multiple-up display window when the multiple-up display window is requested by the user working with the displayed lower level user interface window.

The present invention also provides a computer-readable recording medium storing a program displaying a user interface window desired by a user among user interface windows at a higher level than a current user interface window by displaying a user interface window selected from a multiple-up display window when the multiple-up display window is requested by the user working with the displayed lower level user interface window.

In accordance with an aspect of the present invention, a method of displaying a user interface includes the steps of (a) selecting a menu item in a current user interface window, and (b) switching from the current user interface window to a new user interface window corresponding to the selected menu item, wherein the current user interface window and the new user interface window are displayed together.

The sizes of the current and new user interface windows when displayed together may be smaller than the sizes of the current and new user interface windows when displayed individually.

The method may further comprise the step of (c) selecting one of the current and new user interface windows when the current and new user interface windows are displayed together, wherein the selected user interface window is activated.

The size of the activated user interface window may be larger than the sizes of the current and new user interface windows displayed together.

The number of the current and new user interface windows displayed together may be variable.

When the number of the current and new user interface windows displayed together is large, a selected user interface window among the current and new user interface windows displayed together may be selected by using a switch key.

A screen for displaying a user interface may be divided into an area for displaying the current user interface window and an area for displaying the new user interface window.

The new user interface windows may be displayed at the same or different heights.

The heights of the user interface windows may be determined according to a switching sequence.

The user interface window may be displayed as text or images.

The current and new user interface windows may be displayed in an operation panel of a printer.

In accordance with another aspect of the present invention, a user interface display device comprises a display unit for displaying a current user interface window, a process history storage unit for storing path information when the displayed user interface window is switched, and a control unit for controlling the display unit to display the current user interface window and a new user interface window together using the stored path information.

The current user interface window may include a menu.

The sizes of the current and selected user interface windows displayed together may be smaller than the sizes of the current and selected user interface windows displayed individually.

The display unit may receive a selection of one of the current and new user interface windows and activates the selected user interface window.

The size of the activated user interface window may be larger than the sizes of the current and new user interface windows displayed together.

The number of the current and new user interface windows displayed together may be variable.

When the number of the current and new user interface windows displayed together is large, a selected user interface window among the current and new user interface windows may be selected by using a switch key.

A screen of the display unit may be divided into an area for displaying the current user interface window and an area for displaying the new user interface window.

The new user interface windows may be displayed at different or equal heights.

The heights of the user interface windows may be determined according to a switching sequence.

The new user interface window may be displayed as text or images.

The current and new user interface windows may be displayed in an operation panel of a printer.

An interface information storage unit for storing information regarding the hierarchy of the user interface windows may be provided.

In accordance with yet another aspect of the present invention, a computer-readable recording medium stores a computer program for performing a method of displaying a user interface, the method comprising the steps of (a) selecting a predetermined menu item in a current user interface window, and (b) switching from the current user interface window to a new user interface window corresponding to the selected menu item, wherein the current user interface window and the new user interface window are displayed together.

In accordance with an aspect of the present invention, a method of displaying a user interface window comprises the steps of (a) storing path information for a user interface window, (b) determining whether a multiple-up display window is requested, (c) displaying a multiple-up display window if a multiple-up display window is requested, the multiple up display comprising a plurality of user interface windows, (d) receiving a selection of a user interface window for the plurality of user interface windows, (e) displaying the selected user interface window.

The plurality of user interface windows may comprise a current user interface window and at least one upper level user window corresponding to the stored path information.

The method may further comprise the step of receiving an input to switch to a desired user interface window.

The multiple-up display window may be displayed on a sub-screen area.

The method may further comprise the step of displaying a current user interface window on a main screen area adjacent to the sub-screen area.

In accordance with still another aspect of the present invention, a method of displaying a user interface window comprises the steps of (a) storing path information for a first user interface window, (b) instructing a display device to display the first user interface window and second user interface windows, and (c) displaying a multiple-up display window corresponding to the path information of the first user interface window. The first user interface window is a currently displayed user interface window, and the second user interface windows are previously displayed user interface windows at a higher level than the first user interface window.

The method may further comprise the steps of (d) receiving a selection of one of the second user interface windows displayed in step (c), and (e) displaying the selected second user interface window.

The method may further comprise the step of controlling the top level of the second user interface windows of the multiple-up display window.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram of a user interface display device according to an exemplary embodiment of the present invention;

FIGS. 2A, 2B, and 2C are views showing an example of a hierarchy of user interface windows displayed by the user interface unit shown in FIG. 1;

FIGS. 3A, 3B, and 3C are views showing an aspect of controlling the level of second user interface windows displayed by the user interface unit shown in FIG. 1;

FIGS. 4A, 4B, and 4C are views for explaining the multiple-up display window and switching to a desired second user interface window according to an exemplary embodiment of the present invention;

FIG. 5 is a view for explaining the multiple-up display window and switching to a desired second user interface window according to an exemplary embodiment of the present invention;

FIG. 6 is a flow chart of a user interface displaying method according to an exemplary embodiment of the present invention; and

FIG. 7 is a flow chart of a user interface displaying method according to an exemplary embodiment of the present invention;

FIG. 8 is a perspective view of a printer with an operation panel as a user interface display device according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

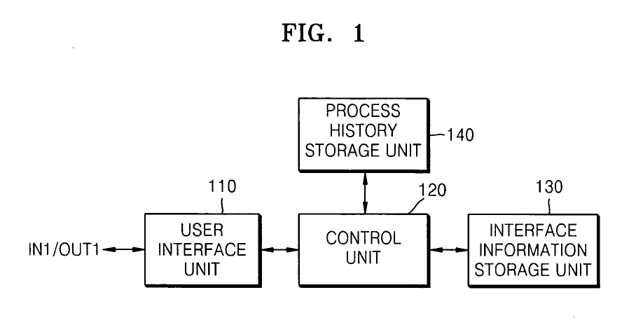

FIG. 1 is a block diagram of a user interface display device according to an exemplary embodiment of the present invention. Referring to FIG. 1, the user interface display device includes a user interface unit 110, a control unit 120, an interface information storage unit 130, and a process history storage unit 140.

The user interface unit 110 displays a user interface window. The user interface unit 110 may operate under the control of the control unit 120. That is, the user interface unit 110 may display a user interface window when instructed to by the control unit 120.

The user interface unit 110 may be a display device such as a touch-screen display or a liquid crystal display panel. When the user interface unit 110 is a touch-screen display, the user interface unit 110 can display the user interface window and can also receive the input of various data by a user touching the display device. The user interface unit 110 may be, for example, an operation panel 310 of a printer 300, as shown in FIG. 8.

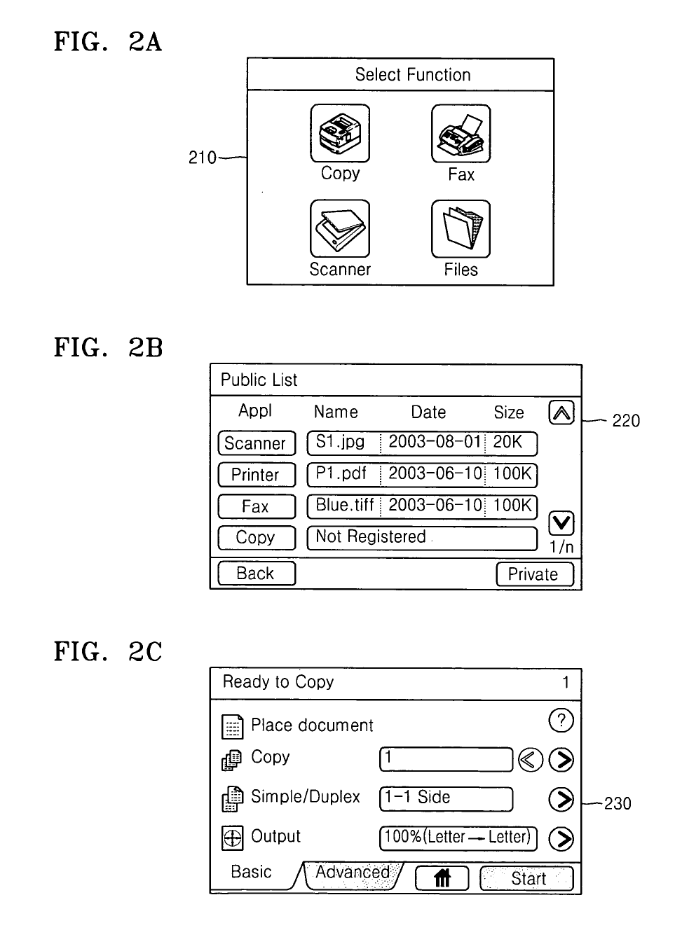

A hierarchy may exist among user interface windows displayed by the user interface unit 110. The hierarchy may be preset. For example, referring to FIGS. 2A, 2B, and 2C, the user interface window 210 may be a top-level user interface window, the user interface window 220 may be a lower level user interface window reached by selecting a menu item in user interface window 210, and the user interface window 230 may be a further lower level user interface window reached by selecting a menu item in user interface window 220.

To this end, interface information regarding the hierarchy is stored in the interface information storage unit 130. The interface information includes information regarding a plurality of user interface windows displayable by the user interface unit 110.

That is, the interface information unit 130 may store information regarding the hierarchy of the user interface windows, and may store information regarding the user interface windows (such as the size and content of the user interface windows). The user interface window may be displayed as text or as images.

A user may select a specific menu item from menus included in the user interface window displayed by the user interface unit 110. The selected menu item is transmitted to the control unit 120.

The control unit 120 reads the interface information corresponding to the selected menu item from the interface information storage unit 130, and instructs the user interface unit 110 to display the user interface window expressed by the read user interface window information.

The user interface unit 110 displays the user interface window according to the instructions from the control unit 120, and the displayed user interface window is at a lower level than the previously displayed user interface window.

During this process, a user may inadvertently switch to a lower level user interface window.

In this case, a user may want to return to the previous user interface window. When switching to the previous user interface window through key strokes or the like, the user interface window that is switched to is at a higher level than the current lower user interface window.

The user interface display device according to the present exemplary embodiment provides a multiple-up display function as described below so as to reduce the complication of keystrokes and accommodate a user's needs. Accordingly, the problems of the conventional user interface display devices may be mitigated.

The process history storage unit 140 may be included in the user interface display device of the present exemplary embodiment to perform the multiple-up display function.

The process history storage unit 140 stores path information of user interface windows displayed by the user interface unit 110. That is, the path information of user interface windows displayed by the user interface unit 110 under the instruction of the control unit 120 is stored in the process history storage unit 140. Stored path information in the process history storage unit 140 may be referred to as a ‘log’.

The user interface unit 110 responds to a multiple-up instruction signal and displays a multiple-up display window comprising a first user interface window and one or more second user interface windows. That is, the user interface unit 110 performs a multiple-up display function in response to the multiple-up instruction signal.

Here, the first user interface window refers to the user interface window currently displayed by the user interface unit 110, and second user interface windows refers to user interface windows previously displayed by the user interface unit 110 that are at a higher level than the first user interface window.

As described above, the user interface unit 110 may display a first user interface window or a second user interface window, and the first user interface window may be displayed after the second user interface window is displayed.

The multiple-up instruction signal is output from the control unit 120. The multiple-up instruction signal can be a signal instructing the user interface unit 110 to display a multiple-up display window using the path information stored in the process history storage unit 140 and the interface information stored in the interface information storage unit 130.

When only the first user interface window is displayed by the user interface unit 110, and a multiple-up display window is requested, the first user interface window and one or more of the second user interface windows may be displayed together by the user interface unit 110.

When the user interface display device according to present exemplary embodiment is instructed to display a multiple-up display window, the multiple-up instruction signal is generated by the control unit 120. The instruction for implementing the multiple-up display window may be performed by key strokes on a key input device or the user interface unit 110. In FIG. 1, IN1 is the multiple-up display instruction input to the user interface unit 110, and OUT1 is the user interface windows.

The multiple-up display window may display all of the user interface windows for which path information is stored, or may display one or more selected user interface windows among all the user interface windows for which path information is stored. That is, the second user interface windows for the multiple-up display may be selected from among all the second user interface windows for which path information is stored.

More specifically, the top level of the second user interface windows of the multiple-up display window may be controlled. In this case, the multiple-up instruction signal instructs the user interface unit 110 to display the user interface windows indicated by the interface information corresponding to the multiple-up path information. The multiple-up path information is path information for the first user interface window and the second user interface windows stored in the process history storage unit 140.

The first user interface window is at a lower level than all the second user interface windows, and thus, the path information of all the second user interface windows may be included in the path information of the first user interface window.

By controlling the top level of the displayed in the multiple-up display window, the number of first and second user interface windows displayed in the multiple-up display window may be controlled. Accordingly, the size of the first and second user interface windows displayed in the multiple-up display window may be controlled.

The user can select one of the user interface windows displayed in the multiple-up display window. At this time, the selection may be performed through the key input device or the user's touch on the user interface unit 110.

By this selection, only the selected second user interface window may be displayed in the entire area of the screen prepared on the user interface unit 110. Accordingly, the user interface window displayed by the user interface unit 110 switches to the second user interface window selected from the first user interface window.

FIGS. 2A, 2B, and 2C show an example of a hierarchy of user interface windows displayed by the user interface unit 110 shown in FIG. 1.

Referring to FIGS. 2A, 2B, and 2C, a user interface window 210 is at a higher level than a user interface window 220, which is at a higher level than a user interface window 230. Accordingly, the user interface windows 210 through 230 are at sequentially lower levels in a hierarchy.

The user interface window 230 is assumed to be the first user interface window, the user interface windows 210 and 220 are the second user interface windows. The first user interface window 230 is displayed after the user interface windows 210 and 220 have been displayed.

Each of the user interface windows 210 through 230 can be displayed on the entire screen of the user interface unit 110 before displaying the multiple-up display window.

To display the multiple-up display window, when the user interface windows are displayed, the path information of the displayed user interface windows is stored.

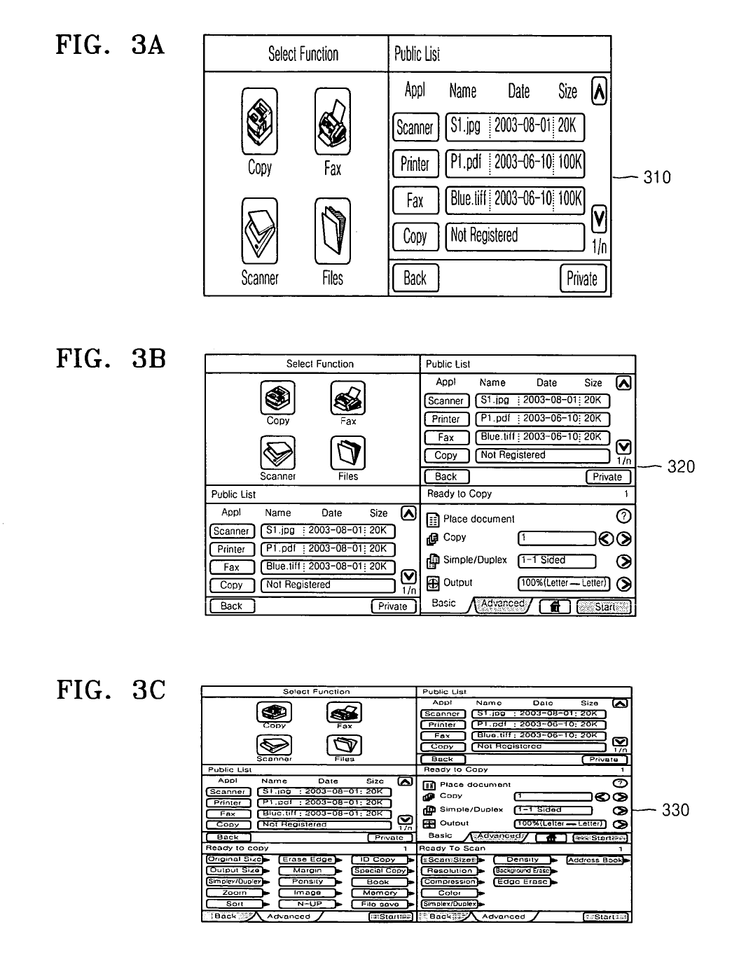

FIGS. 3A, 3B, and 3C are views showing an aspect of controlling the levels of the second user interface windows displayed by the user interface unit 110 shown in FIG. 1. That is, the multiple-up display window may display all the user interface windows corresponding to the path information stored in the process history storage unit 140, as in image 330 (where six user interface windows are displayed). Alternatively, the multiple-up display window may display user interface windows corresponding to a portion of the path information stored in the process history storage unit 140, as shown in images 310 and 320 (where two and four user interface windows are displayed, respectively).

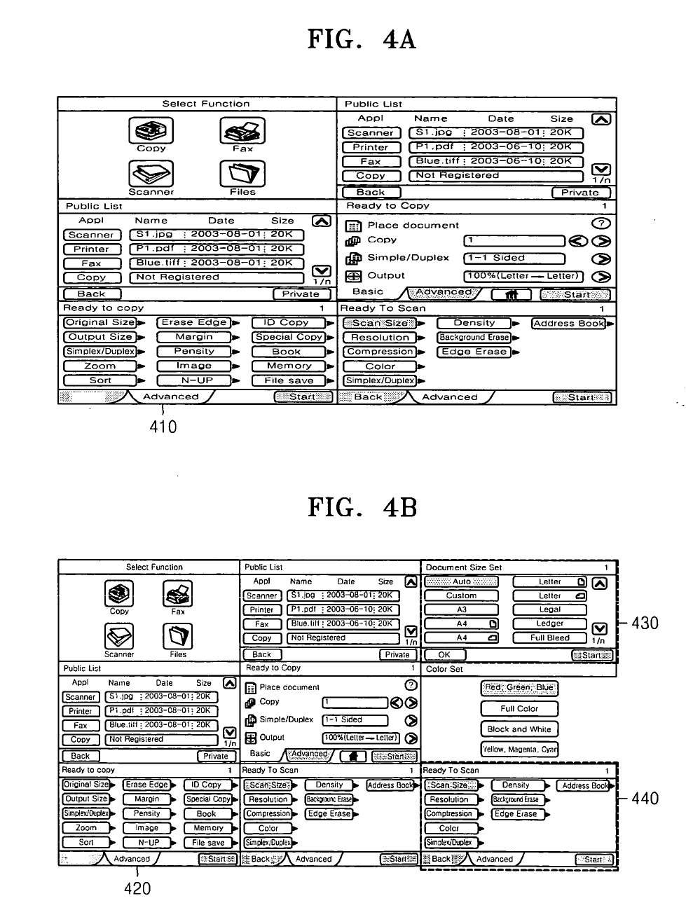

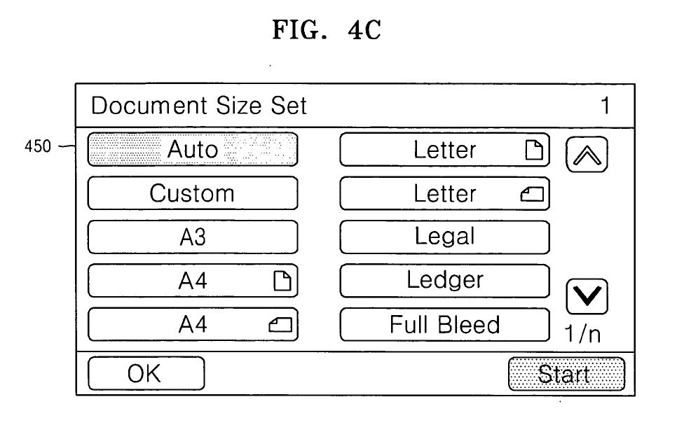

FIGS. 4A, 4B, and 4C are views for explaining the multiple-up display window and switching to a desired second user interface window according to an exemplary embodiment of the present invention.

The multiple-up display window 420 may show all the user interface windows corresponding to the path information stored in the process history storage unit 140, as illustrated in FIG. 4B. Alternatively, the multiple-up display window 410 may show only a portion of the user interface windows in the path information stored in the process history storage unit 140, as illustrated in FIG. 4A.

When the user intends to switch to a specific second user interface window 430 displayed in the multiple-up display window 420, the user can select the specific second user interface window 430. The selected second user interface window 430 may be displayed in the entire area 450 of the screen by the user interface unit 110, as shown in FIG. 4C. In this way, the user interface window displayed by the user interface unit 110 can be switched from the first user interface window 440 to the selected second user interface window 430.

According to the present exemplary embodiment of the present invention, the sizes of the first user interface window and the second user interface windows may be the same. That is, the first user interface window may not be distinguished visually from the second user interface windows on the multiple-up display window by the user interface unit 110.

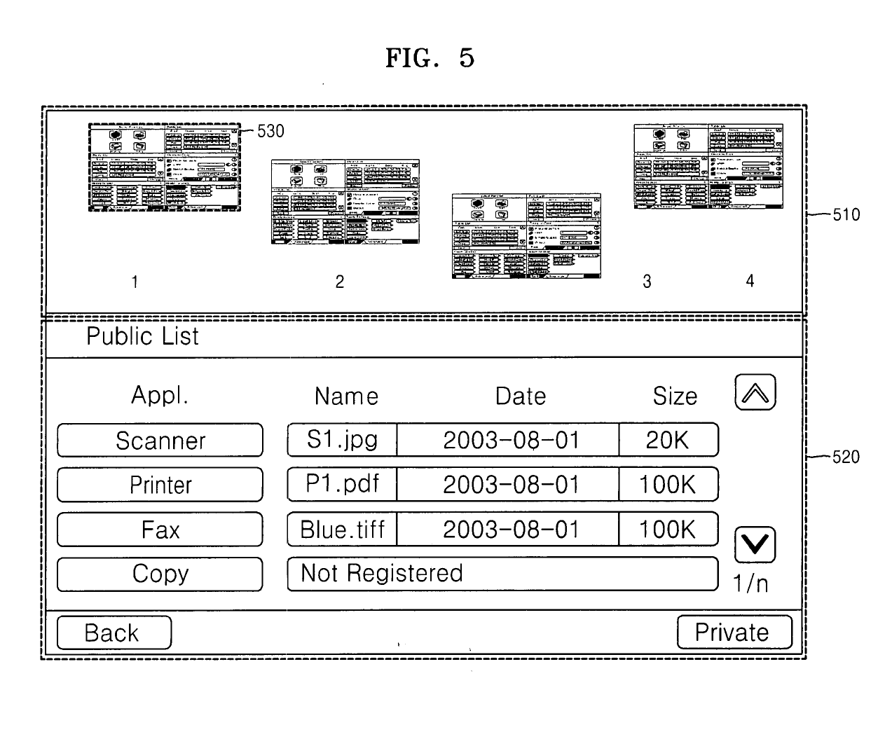

FIG. 5 is a view for explaining the multiple-up display window and switching to a desired second user interface window according to another exemplary embodiment of the present invention.

When the user intends to switch to a specific second user interface window 530 displayed in the multiple-up display window, the user can select the specific second user interface window 530. In that case, the selected second user interface window 530 may be displayed in the entire area prepared by the user interface unit 110. In this way, the user interface window displayed by the user interface unit 110 may switch from a first user interface window to the selected second user interface window 530.

According to the present exemplary embodiment of the present invention, the area in which the first user interface window is displayed can be visually distinguished from a multiple-up display area on the screen on the user interface unit 110. As shown in FIG. 5, the screen on the user interface unit 110 may be divided into a main screen 520 and a sub screen 510, and the first user interface window is displayed on the main screen 520, and the second user interface windows are displayed on the sub screen 510.

The second user interface windows displayed on the sub screen 510 may be displayed at the same or different heights. Here, “height” refers to the distance from the bottom of the sub screen 510. The heights of the windows may be determined according to a switching sequence.

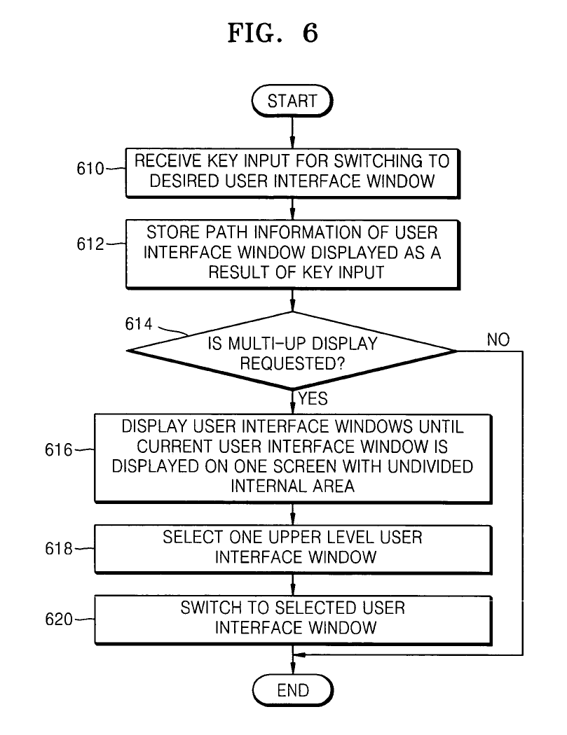

FIG. 6 is a flow chart of a user interface displaying method according to a first exemplary embodiment of the present invention. Referring to FIG. 6, the user interface displaying method includes the steps of displaying a user interface window in response to a key input received from a user, and switching to a desired user interface window at a higher level than the displayed user interface window after the user selects the desired user interface window from the multiple-up display window when the multiple-up display window is requested by a user operation (610 through 620).

The user interface unit 110 receives a key input from the user intending to switch to the desired user interface window (operation 610), and the path information of all the user interface windows displayed in response to the key input is stored in the process history storage unit 140 (operation 612).

The first and second user interface windows are the user interface windows displayed by the user interface unit 110 in operation 610.

The control unit 120 determines whether a multiple-up display window is requested by the user (operation 614). When it is determined that a multiple-up display window is requested (614), the control unit 120 instructs the user interface unit 110 to display a multiple-up display window, and the user interface unit 110 displays the first user interface window and one or more second user interface windows on one screen according to the instruction (operation 616).

At this time, the user interface unit 110 can display the first user interface window and one or more second user interface windows on one screen with an undivided internal area, as shown in FIG. 4A or 4B.

The user may select an upper level user interface window among the user interface windows displayed in the multiple-up display window (operation 618). After operation 618, the control unit 120 instructs the user interface unit 110 to display the selected user interface window. More specifically, the control unit 120 instructs the user interface unit 110 to display the selected user interface window on the entire area of the screen of the user interface unit 110.

When the number of the current and new user interface windows displayed together on the user interface unit 110 is large, a selected user interface window among the current and new user interface windows displayed together may be selected by using a switch key. That is, rather than selecting a user interface unit by touching the user interface unit 110, a user may select one of the selected user interface windows by using a key.

Accordingly, the user interface window displayed by the user interface unit 110 switches from the currently displayed user interface window to the selected user interface window (operation 620).

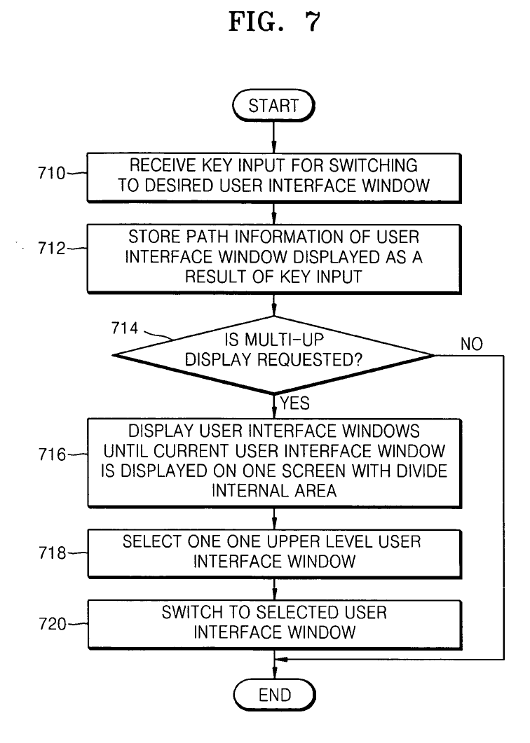

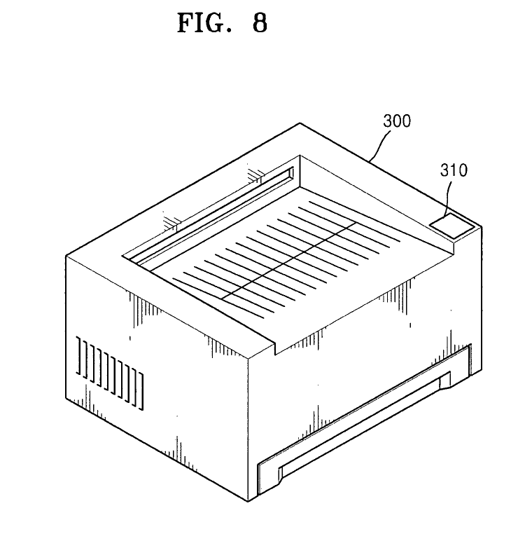

FIG. 7 is a flow chart of a user interface displaying method according to a second exemplary embodiment of the present invention. Referring to FIG. 7, the user interface displaying method includes the steps of displaying a user interface window in response to a key input received from a user, and switching to a desired user interface window at a higher level than the displayed user interface window after the user selects the desired user interface window from the user interface windows displayed in the multiple-up display window when the multiple-up display window is requested by a user (operation 710 through 720).

The user interface unit 110 receives a key input from the user intending to switch to the desired user interface window (operation 710), and the path information of all the user interface windows displayed in response to the key input is stored in the process history storage unit 140 (operation 712).

The first and second user interface windows are the user interface windows displayed by the user interface unit 110 in operation 710.

The control unit 120 determines whether a multiple-up display window is requested by the user (operation 714). When it is determined that a multiple-up display window is requested (operation 714), the control unit 120 instructs the user interface unit 110 to display a multiple-up display window, and the user interface unit 110 displays the first user interface window and one or more second user interface windows on one screen according to the instruction (operation 716).

At this time, the user interface unit 110 can display the first user interface window and one or more second user interface windows on one screen with a divided internal area, as shown in FIG. 5.

The user can select an upper level user interface window among the user interface windows displayed in the multiple-up display window (operation 718). After operation 718, the control unit 120 instructs the user interface unit 110 to display the selected user interface window. More specifically, the control unit 120 instructs the user interface unit 110 to display the selected user interface window on the entire area of the screen of the user interface unit 110.

Accordingly, the user interface window displayed by the user interface unit 110 switches from the first user interface window to the selected user interface (operation 720).

The invention can also be embodied as computer readable code on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

As described above, the user interface display device and method according to the exemplary embodiments of the present invention can illustrate the path of user interface windows to the user by displaying the lower level user interface window and the upper level user interface windows which have been previously displayed together when a multiple-up display window is requested by a user viewing the displayed lower level user interface window. Further, the user interface display device and method according to the exemplary embodiments of the present invention are capable of reducing the complexity of keystrokes requested to switch from the lower level user interface window to the higher level user interface window desired by the user and accommodating the user's needs by displaying a multiple-up display window and allowing the user to select one of the user interface windows displayed in the multiple-up display window when the multiple-up display window is requested by a user viewing the lower level user interface window.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of displaying a user interface, comprising the steps of:
(a) selecting a menu item in a current user interface window; and
(b) switching from the current user interface window to a new user interface window corresponding to the selected menu item,
wherein the current user interface window and the new user interface window are displayed together in a multiple-up display window.

2. The method of displaying a user interface of claim 1, wherein the sizes of the current and new user interface windows when displayed together are smaller than the sizes of the current and new user interface windows when displayed individually.

3. The method of displaying a user interface of claim 1, further comprising the step of (c) selecting one of the current and new user interface windows when the current and new user interface windows are displayed together, wherein the selected user interface window is activated.

4. The method of displaying a user interface of claim 3, wherein the size of the activated user interface window is larger than the sizes of the current and new user interface windows displayed together.

5. The method of displaying a user interface of claim 1, wherein the number of the current and new user interface windows displayed together is variable.

6. The method of displaying a user interface of claim 1, wherein, when the number of the current and new user interface windows displayed together is large, a selected user interface window among the current and new user interface windows displayed together may be selected by using a switch key.

7. The method of displaying a user interface of claim 1, wherein a screen for displaying a user interface is divided into an area for displaying the current user interface window and an area for displaying the new user interface window.

8. The method of displaying a user interface of claim 7, wherein the new user interface windows are displayed at the same or different heights.

9. The method of displaying a user interface of claim 8, wherein the heights of the user interface windows are determined according to a switching sequence.

10. The method of displaying a user interface of claim 1, wherein the user interface window is displayed as text or images.

11. The method of displaying a user interface of claim 1, wherein the current and new user interface windows are displayed in an operation panel of a printer.

12. A user interface display device comprising:
a display unit for displaying a current user interface window;
a process history storage unit for storing path information when the displayed user interface window is switched; and
a control unit for controlling the display unit to display the current user interface window and a new user interface window together using the stored path information.

13. The user interface display device of claim 12, wherein the current user interface window includes a menu.

14. The user interface display device of claim 12, wherein the sizes of the current and selected user interface windows displayed together are smaller than the sizes of the current and selected user interface windows displayed individually.

15. The user interface display device of claim 12, wherein the display unit receives a selection of one of the current and new user interface windows and activates the selected user interface window.

16. The user interface display device of claim 15, wherein the size of the activated user interface window is larger than the sizes of the current and new user interface windows displayed together.

17. The user interface display device of claim 16, wherein the number of the current and new user interface windows displayed together is variable.

18. The user interface display device of claim 12, wherein, when the number of the current and new user interface windows displayed together is large, a selected user interface window among the current and new user interface windows may be selected by using a switch key.

19. The user interface display device of claim 12, wherein a screen of the display unit is divided into an area for displaying the current user interface window and an area for displaying the new user interface window.

20. The user interface display device of claim 19, wherein the new user interface windows are displayed at different or equal heights.

21. The user interface display device of claim 20, wherein the heights of the user interface windows are determined according to a switching sequence.

22. The user interface display device of claim 12, wherein the new user interface window is displayed as text or images.

23. The user interface display device of claim 12, wherein the current and new user interface windows are displayed in an operation panel of a printer.

24. The user interface display device of claim 12, further comprising an interface information storage unit for storing information regarding the hierarchy of the user interface windows.

25. A computer-readable recording medium that stores a computer program for performing a method of displaying a user interface, the method comprising the steps of:
(a) selecting a predetermined menu in a current user interface window; and
(b) switching from the current user interface window to a new user interface window corresponding to the selected menu,
wherein the current user interface window and the new user interface window are displayed together in a multiple-up display window.

26. A method of displaying a user interface window, comprising the steps of:
(a) storing path information for a user interface window;
(b) determining whether a multiple-up display window is requested;
(c) displaying a multiple-up display window if a multiple-up display window is requested, the multiple up display comprising a plurality of user interface windows;
(d) receiving a selection of a user interface window for the plurality of user interface windows;
(e) displaying the selected user interface window.

27. The method of claim 26, wherein the plurality of user interface windows comprises a current user interface window and at least one upper level user window corresponding to the stored path information.

28. The method of claim 26, further comprising the step of receiving an input to switch to a desired user interface window.

29. The method of claim 26, wherein the multiple-up display window is displayed on a sub-screen area.

30. The method of claim 29, further comprising the step of displaying a current user interface window on a main screen area adjacent to the sub-screen area.

31. A method of displaying a user interface window comprising the steps of:
(a) storing path information for a first user interface window;
(b) instructing a display device to display the first user interface window and second user interface windows; and
(c) displaying a multiple-up display window corresponding to the path information of the first user interface window,
wherein the first user interface window is a currently displayed user interface window, and the second user interface windows are previously displayed user interface windows at a higher level than the first user interface window.

32. The method of claim 31, further comprising the steps of:
(d) receiving a selection of one of the second user interface windows displayed in step (c); and
(e) displaying the selected second user interface window.

33. The method of claim 26, further comprising the step of controlling the top level of the second user interface windows of the multiple-up display window.
